(19) United States
(12) Patent Application Publication
(10) Pub. No.: US 2016/0207248 A1
(43) Pub. Date: Jul. 21, 2016

(54) IMPRINT APPARATUS, IMPRINTING METHOD, AND METHOD OF MANUFACTURING ARTICLES

(71) Applicant: CANON KABUSHIKI KAISHA, Tokyo (JP)

(72) Inventor: Hiroshi Sato, Utsunomiya-shi (JP)

(21) Appl. No.: 14/993,975

(22) Filed: Jan. 12, 2016

(30) Foreign Application Priority Data
Jan. 16, 2015 (JP) 2015-006997

(51) Int. Cl. B29C 59/00; B29C 59/02

(52) U.S. Cl. CPC B29C 59/002; B29C 59/02

(57) ABSTRACT

The invention provides an imprint apparatus configured to form a pattern including: a plurality of detectors configured to detect marks, the plurality of detectors including a first detector and a second detector, and a control unit, the control unit causing the first detector to detect a first mark on the mold and a first mark on the substrate formed in the first region, performing a first alignment, causing the first detector to detect the first mark on the mold and the first mark on the substrate, and then causing the second detector to detect a second mark formed on the second region of the mold and a second mark on the substrate while moving the first detector.

### BACKGROUND OF THE INVENTION

1. Field of the Invention

The present invention relates to an imprint apparatus, an imprinting method, and a method of manufacturing articles.

2. Description of the Related Art

An imprinting technology is a technology for transferring a pattern formed on a mold onto an imprint material supplied onto a substrate, and is proposed as one of technology for manufacturing semiconductor devices or magnetic storage media. An imprint apparatus is configured to bring the imprint material (for example, a photo-curing resin) supplied onto the substrate into contact with the mold having the pattern formed thereon and let the imprint material be cured in a contact state. The pattern can be formed on (transferred to) the imprint material on the substrate by increasing a distance between the cured imprint material and the mold and separating the mold from the imprint material.

In such an imprint apparatus, so-called a die-by-die system is employed for alignment between the mold and the substrate. The die-by-die system is configured to detect marks formed on the mold and marks formed on the substrate for each region (shot region) where the pattern is to be formed, and measure a relative position between the mold and the substrate and a shape difference between the shot regions. The marks used for the alignment are detected by detectors (scopes) provided on the imprint apparatus to correct the position.

The detectors are configured to detect the plurality of marks by moving within the imprint apparatus. In Japanese Patent Laid-Open No. 2013-219331, an imprint apparatus configured to deform a mold into a convex shape with respect to a substrate to bring the mold into contact with an imprint material is described. In the imprint apparatus of Japanese Patent Laid-Open No. 2013-219331, a configuration in which the plurality of detectors move within the imprint apparatus to sequentially detect the marks formed on regions where the mold and the imprint material are in contact with each other is proposed. In this manner, the detectors are configured to detect marks formed on the mold and marks formed on the substrate sequentially depending on contact between the mold and resin.

In the case where the alignment between the substrate and the mold is performed in the die-by-die system, intervals of the marks to be detected by the detectors in the substrate (mold) plane can be large when measuring misalignment in rotational component (rotational misalignment). Specifically, when measuring misalignment of rotational component (rotational misalignment) between the substrate and the mold, it is effective to use a result of detection of the marks which are located away from each other. Therefore, in the die-by-die system, eventually, a result of detection of the plurality of marks formed in the periphery of the shot region obtained by using the plurality of detectors is used for alignment.

However, since the imprint apparatus of the related art is configured to deform the mold into a convex shape to bring the mold into contact with the imprint material, detection of the marks formed in the periphery of the shot region comes to a latter half of contact process. In the case of moving the detectors for detecting the plurality of marks, remaining detectors that are not moved wait until movement of the detectors for detecting the plurality of marks by movement is completed and then detect the marks. A further reduction of period of time required for a process of detecting the marks and an alignment process to achieve an imprint apparatus having further improved productivity is demanded.

### SUMMARY OF THE INVENTION

The invention provides an imprint apparatus configured to form a pattern of an imprint material on a substrate by using a mold including: a plurality of detectors configured to detect marks formed on the substrate and marks formed on the mold, the plurality of detectors including a first detector and a second detector; and a control unit configured to control the imprint apparatus, the control unit bringing the imprint material and the mold into contact with each other so that a first region and a second region of the mold contact sequentially with the imprint material, causing the first detector to detect a first mark on the mold and a first mark on the substrate formed in the first region, performing a first alignment between the substrate and the mold on the basis of a result of detection of the first mark on the mold and the first mark on the substrate, causing the first detector to detect the first mark on the mold and the first mark on the substrate, and then causing the second detector to detect a second mark formed on the second region of the mold and a second mark on the substrate while moving the first detector.

Further features of the present invention will become apparent from the following description of exemplary embodiments with reference to the attached drawings.

### BRIEF DESCRIPTION OF THE DRAWINGS

FIG. 1 is a drawing illustrating an imprint apparatus according to an embodiment of the invention.

FIGS. 2A to 2D are drawings illustrating marks used for alignment according to the embodiment of the invention.

FIG. 3 is a drawing illustrating locations of detectors according to the embodiment of the invention.

FIG. 4 is a drawing illustrating a shape of a mold at the time of imprinting according to the embodiment of the invention.

FIG. 5 is a flowchart of the embodiment of the invention.

FIGS. 6A and 6B are drawings illustrating states of driving of the detectors according to the embodiment of the invention.

### DESCRIPTION OF THE EMBODIMENTS

An embodiment of the invention will be described with reference to the attached drawings in detail below. In the respective drawings, the same members are denoted by the same reference numerals and overlapped description will be omitted.

### Embodiment

### Imprint Apparatus

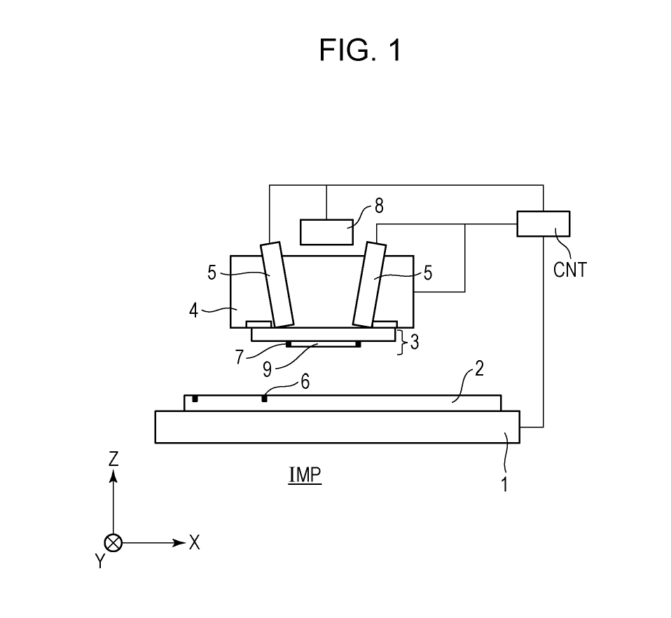

An imprint apparatus IMP of an embodiment of the invention will be described with reference to FIG. 1. As illustrated in FIG. 1, the imprint apparatus IMP includes a substrate stage 1 configured to hold a substrate 2, a mold holding portion 4 (imprint head) configured to hold a mold 3, detectors 5 (scopes) configured to detect marks used for alignment, and a light source 8 configured to irradiate light for curing an imprint material. Examples of the marks used for alignment include substrate-side marks 6 formed on the substrate 2 for each of shot regions and mold-side marks 7 formed on the mold 3. The shot regions indicate regions on the substrate 2 to which a pattern 9 (pattern region) formed on the mold 3 is transferred. The imprint apparatus IMP further includes a control unit CNT configured to control imprinting operation. The imprint apparatus IMP may be provided with a dispenser configured to coat (supply) the imprint material onto the substrate 2.

An imprinting technology is a technology for forming a pattern on the substrate 2 by using the imprint apparatus IMP configured as described above. The imprint apparatus IMP is an apparatus configured to form a fine pattern on the substrate 2 such as a silicon substrate or a glass plate with the mold provided with a fine pattern formed thereon as an original plate by using an electron beam lithography apparatus and the like. The fine pattern is formed by supplying the imprint material onto the substrate, bringing the imprint material and the mold into contact with each other, and letting the imprint material be cured in a contact state.

The imprinting technology includes a heat-cycle method and a light-curing method. In the heat-cycle method, a pattern is formed by heating a thermoplastic resin to a temperature not lower than a glass-transition temperature, passing the mold against the substrate by the intermediary of the resin in a state in which fluidity of the resin is increased, cooling the resin, and then separating the mold from the resin. In the light-curing method, a pattern is formed by using a UV-curing resin, irradiating the resin with UV light in a state in which the resin and the bringing substrate into contact with each other, then separating the mold the resin. The heat-cycle method is associated with a decrease of dimensional accuracy due to an increase in transfer time and temperature variations caused by the temperature control. In contrast, the light-curing method has no such a problem, and thus the light-curing method is advantageous in mass-production of nano-scale semiconductor devices at this moment.

The substrate stage 1 includes a substrate chuck configured to hold the substrate 2. The substrate chuck may hold the substrate 2 by vacuum contact, for example. The substrate stage 1 includes a driving mechanism and has an ability to move the substrate 2 along a XY plane. The safer stage 1 may be configured to be driven also in a Z-direction.

The mold holding portion 4 includes a mold chuck configured to hold the mold 3. The mold chuck may hold the mold 3, for example, by the vacuum contact. The mold holding portion 4 includes a driving mechanism, and has an ability to move the mold 3 in a direction toward the substrate 2 (Z-direction). The driving mechanism may be configured to have an ability to drive the substrate 2 along the XY plane. In addition, the mold holding portion 4 may be provided with a deforming mechanism configured to change the shape of the mold 3. The deforming mechanism has an ability to deform the mold 3 in a convex shape with respect to the substrate 2 and deform a region where the pattern 9 is formed (pattern region) in compliance with the deformation of the shot region of the substrate 2.

The detectors 5 detect substrate-side marks 6 and mold-side marks 7, and measure a relative position and a shape difference between the shot region of the substrate 2 and a patterned region of the mold 3 by using a result of detection. In the embodiment, the detectors 5 are held by the mold holding portion 4. The detectors 5 are held by the mold holding portion 4 in an inclined posture in order to avoid being irradiated with light from the light source 8 after detection of the substrate-side marks 6 and the mold-side marks 7. If the detectors 5 may be moved (retracted) to positions which are not irradiated with light when the light source 8 emits light, the detectors 5 do not have to be inclined. Alternatively, the detectors 5 may be located so that interference of optical paths of exposure light with optical paths of the detectors is avoided by a synthesizing mirror or the like. The detectors 5 do not have to be held by the mold holding portion 4 as long as the substrate-side marks 6 and the mold-side marks 7 can be imaged by an optical system (a relay optical system), and the detectors 5 may be located at positions away from the mold 3.

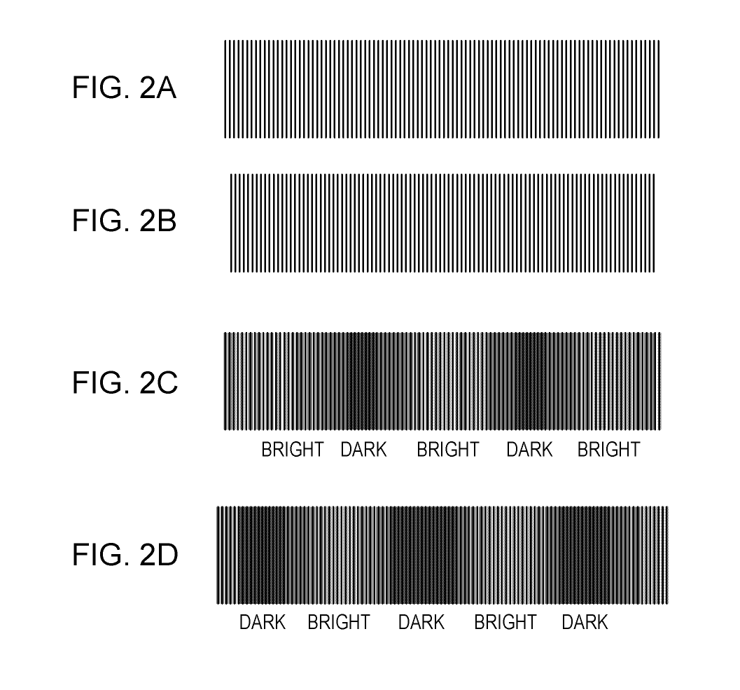

The detectors 5 detect a moiré pattern which is generated when the substrate-side marks 6 illustrated in FIG. 2A and the mold-side marks 7 illustrated in FIG. 2B are overlapped with each other. The detectors 5 detect the moiré pattern illustrated in FIG. 2C and FIG. 2D and measure a relative position between the substrate 2 and the mold 3 from the result of detection.

The relative position of the shot region of the substrate 2 and the patterned region on the mold 3 are measured by using the detectors 5. However, in the imprint apparatus, part of the pattern 9 on the mold 3 may be transferred to a peripheral portion (edge shot) of the substrate 2. A plurality of chips may be formed in the shot region, and patterns of some of chips may be formed by performing imprinting in the edge shot. In this case, the relative positions between the substrate 2 and the mold 3 may be measured by arranging the substrate-side marks 6 and the mold-side marks 7 in the peripheries of the chips, moving the detectors 5, and detecting the marks in the peripheries of the chips by moving the detectors 5.

Referring now to FIGS. 2A to 2D, a method of measuring the relative position between the two marks by using the moiré pattern will be described. The substrate-side marks 6 and the mold-side marks 7 illustrated in FIG. 2A and FIG. 2B are grating marks having pitches different from each other. When these grating marks are overlapped with each other, a bright-dark stripe pattern generates as illustrated in FIG. 2C. The stripe pattern illustrated in FIG. 2C corresponds to moiré pattern. The moiré pattern is varied in positions of bright portions and dark portions depending on the relative position between the two grating marks. For example, if one of the two grating marks is out of alignment slightly to the right, the moiré pattern illustrated in FIG. 2C is varied to a moiré pattern illustrated in FIG. 2D. Since the moiré pattern is generated as a large bright-dark stripe pattern by enlarging an actual amount of misalignment between the two grating marks, the relative position between the two grating marks may be measured with high degree of accuracy by detecting the moiré pattern even though a resolving power of the detectors 5 is low. The imprint apparatus IMP has an ability to measure the relative position between the substrate 2 and the mold 3 having the grating marks formed thereon by measuring the relative position between the grating marks. When inclining the scopes as described above, illumination light needs to be introduced to an optical path of a desired detectors by setting a non-measurement direction of the marks on the mold or the substrate into a grating pattern and diffracting light. In order to do so, the marks on the mold or the substrate can be formed into a checker pattern.

Although the method of measurement of the relative position between the substrate 2 and the mold 3 by using the moiré pattern has been described thus far, the method of measurement is not limited thereto. Since only the relative position between the substrate 2 and the mold 3 needs to be measured, for example, the relative position may be measured by detecting the image of the marks formed on the substrate 2 and an image of the marks formed on the mold 3 simultaneously within the same field of view, or by detecting the images of the respective marks in different fields of view, and comparing the positions of the mark images with a sensor reference or the like.

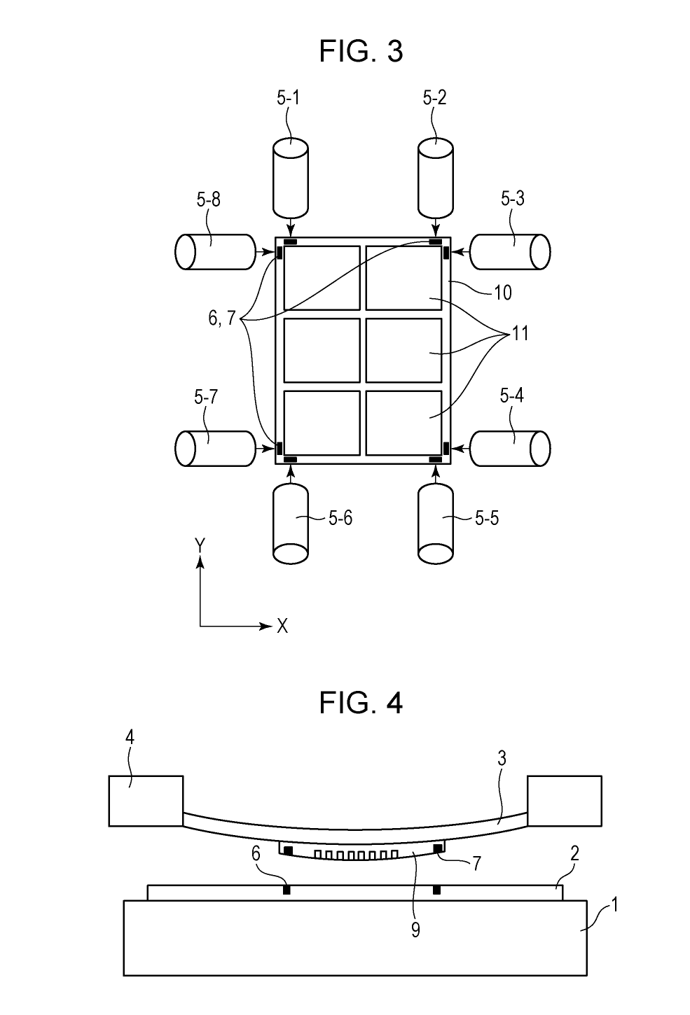

FIG. 3 illustrates a positional relationship between the substrate-side marks 6 and the mold-side marks 7, the detectors 5 configured to detect the substrate-side marks 6, and the mold-side marks 7 viewing from above the substrate 2 (mold 3). A shot 10 (a shot region on the substrate 2 and a region for forming the pattern 9 on the mold 3) illustrated in FIG. 3 includes six chips 11, and includes the substrate-side marks 6 and the mold-side marks 7 at four corners (peripheral region) of the shot 10. In a location example of the marks in FIG. 3, each corner has a mark in an X-direction and a mark in a Y-direction. Since FIG. 3 shows the substrate 2 and the mold 3, the substrate-side marks 6 and the mold-side marks 7 are seen in an overlapped manner. The substrate-side marks 6 (mold-side marks 7) are black out means that measurement of the relative position between the substrate-side marks 6 and the mold-side marks 7 is available.

The larger the intervals between the marks to be detected in a substrate (mold) plane, the better for obtaining the shape difference between the shot region of the substrate 2 and the pattern 9 on the mold 3 and an amount of rotation thereof. The reason is that accuracy of measured values of the shape difference and the amount of rotation by using the detected marks is improved. In particular, when measuring rotational misalignment between the shot region of the substrate 2 and the pattern 9 on the mold 3, it is effective to use a result of detection of the marks located at positions away from each other. In the embodiment, marks at four points in the X-direction are detected by using a detector 5-1, a detector 5-2, a detector 5-5, and a detector 5-6, and marks at four points in the Y-direction are detected by using a detector 5-3, a detector 5-4, detector 5-7, and a detector 5-8. The detectors are not limited to modes of the detectors illustrated in FIG. 3, and detectors configured to detect marks in the X-direction and the Y-direction simultaneously may also be used. Depending on accuracy of alignment, the number of the detectors may vary.

A case of measuring the relative position between the substrate 2 and the mold 3 by using marks at eight points illustrated in FIG. 3 will be described. For example, in the result of detection of the marks at the eight points, if a value of measurement of the relative position indicates that the mold-side marks 7 are deviated from the substrate-side marks 6 toward the outside of the shot 10, it means that a magnification difference exists between the shot region of the substrate 2 and the pattern 9 on the mold 3.

By detecting marks at a plurality of positions in this manner, relative shape differences such as difference in magnification between the shot region and the pattern 9 on the mold 3, deformation into a trapezoidal shape or a parallelogrammatic shape, distortion, and the like may be measured. On the basis of the result of measurement, the pattern 9 on the mold 3 is deformed or the shot region of the substrate 2 is deformed. For example, such differences may be corrected by using a mechanism configured to compress and decompress the mold 3 in the XY direction. Simple misalignment in the XY direction and misalignment of rotational component may be corrected by shifting or rotationally moving at least one of the substrate 2 and the mold 3 in the XY direction.

FIG. 4 illustrates the mold 3 deformed into a convex shape by applying a force. In this state, the mold 3 is brought into contact with the imprint material on the substrate 2. In the process of bringing the imprint material on the substrate 2 and the mold 3 into contact with each other, air bubbles may remain in a concave portion of the pattern 9 formed on the mold 3. The imprinting method in FIG. 4 approaches the substrate 2 from a position near a center of the pattern 9 and comes into contact with the imprint material. A contact region with the imprint material is increased toward an outer periphery of the pattern 9, and the concave portion of the pattern 9 is filled with the imprint material. The plurality of marks formed on the mold 3 contact sequentially with the imprint material from the center toward the periphery of the pattern 9. In this manner, residual air bubbles in the concave portion of the pattern 9 may be reduced by deforming the mold 3 with respect to the substrate 2 in a convex shape and bringing the mold 3 into contact with the imprint material as illustrated in FIG. 4.

The imprinting method illustrated in FIG. 4 is effective for reducing a pattern transfer error due to the residual air bubbles. However, as illustrated in FIG. 3, in the case of detecting the marks located around the periphery of the shot 10, mark detection cannot be performed until the periphery of the shot 10 is filled with the imprint material. Therefore, the process of filling the pattern 9 with the imprint material and the process of mark detection (the process of alignment) cannot be processed in parallel, and thus the imprinting process needs time. Consequently, productivity is lowered.

In the case where the relative position between the mold 3 and the substrate 2 is varied after the imprint material has been brought into contact with (or filled in) the entire surface of the pattern 9, a large force is required for driving. The reason is that a shearing force generated by the imprint material between the mold 3 and the substrate 2 is increased and thus a large force is required for driving after the entire surface of the pattern 9 has been brought into contact with the imprint material. Even though driving is achieved, distortion in the shape of the shot may occur, and thus alignment may take time due to deformation of the mold 3 and the substrate 2.

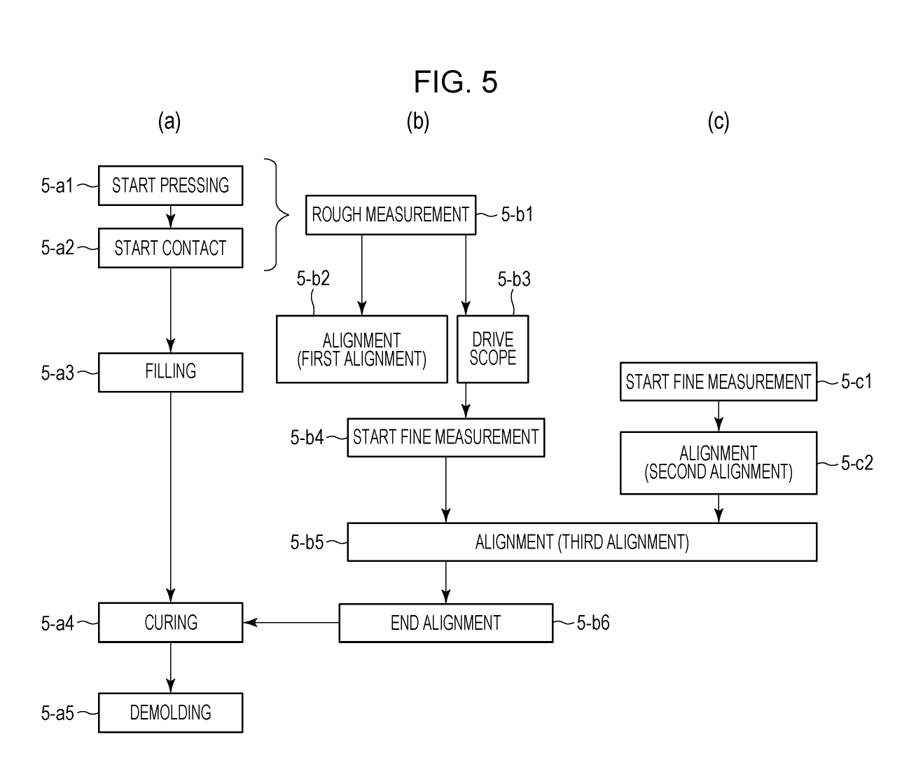

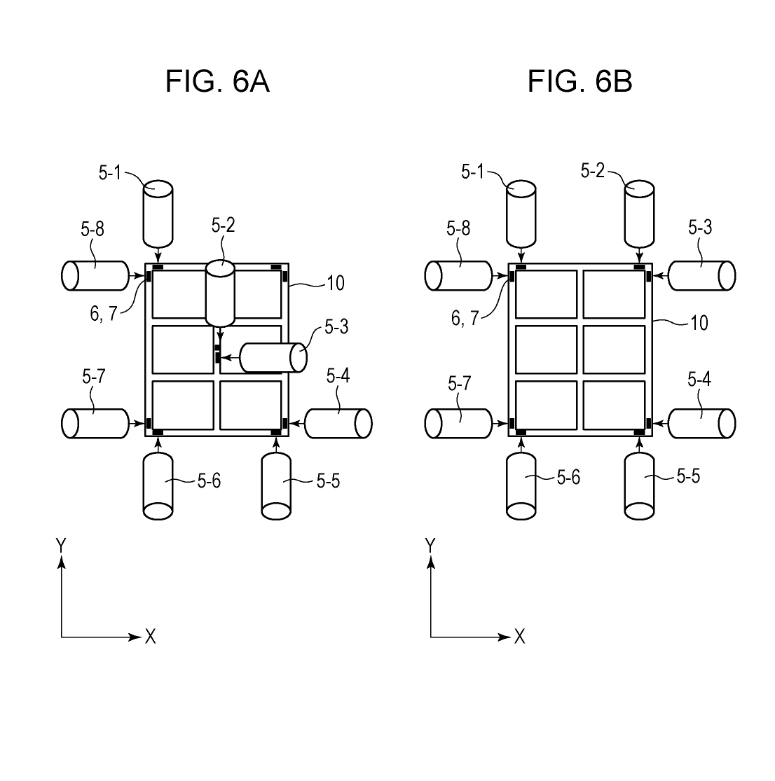

Therefore, the embodiment will be described with reference to FIG. 5 and FIGS. 6A and 6B.

FIG. 5 is a flowchart of the embodiment. The flowchart in FIG. 5 is implemented by controlling the respective mechanisms in the imprint apparatus by a control unit CNT provided in the imprint apparatus IMP. FIGS. 6A and 6B are schematic drawings illustrating states of driving of the detectors 5 according to the embodiment.

FIG. 5(a) illustrates a transfer process configured to transfer a pattern on the imprint material on the substrate 2 by using the pattern 9 on the mold 3. FIG. 5(b) illustrates an alignment process on the basis of the substrate-side marks 6 and the mold-side marks 7 detected by using the detectors 5 (first detectors) configured to move within the imprint apparatus. FIG. 5(c) illustrates an alignment process on the basis of the substrate-side marks 6 and the mold-side marks 7 detected by using the detectors 5 (second detectors) without moving within the imprint apparatus (without detecting the plurality of marks). These processes are performed in parallel.

The transfer process illustrated in FIG. 5(a), the alignment processes (first alignment process and a third alignment process) in association with movements of the detectors illustrated in FIG. 5(b), and the alignment process (second alignment process) without the movements of the detectors illustrated in FIG. 5(c) will be described in detail.

In step 5-a1, the distance between the pattern 9 on the mold 3 and the substrate 2 to which the imprint material is supplied is reduced. At this time, only at least one of the substrate stage 1 and the mold holding portion 4 needs to be driven. The mold 3 approaches the imprint material in a state of being deformed into a convex shape as illustrated in FIG. 4 without being inclined. As a modification of the embodiment, there are a case where the mold 3 is kept flat, is inclined with respect to the substrate 2, and is brought into contact with the imprint material, and a case where the mold 3 is deformed into a convex shape and is brought into contact with the imprint material in a state in which the mold 3 is deformed into a convex shape and is inclined.

In Step 5-a2, a distal end of the pattern 9 deformed into the convex shape comes into contact with the imprint material (start contact with liquid). The positions of the detectors 5 at this time are illustrated in FIG. 6A. In the embodiment, the mold 3 is deformed into a convex shape to bring the mold 3 into contact with the imprint material. Therefore, a position near the center of the shot 10 corresponds to a position where the mold 3 and the imprint material come into contact with each other (the position of starting contact with liquid). A first mark is provided at a position (first region) of the mold 3 which firstly comes into contact with the imprint material on the substrate, and a first mark is provided on the substrate 2 at a position corresponding to the first mark on the mold. The alignment between the substrate 2 and the mold 3 is achieved in parallel with the process of filling the pattern 9 on the mold 3 with the imprint material by detecting the first mark on the mold and the first mark on the substrate by the detectors 5. Since the mold 3 is deformed into the convex shape here, the center of the region provided with the pattern 9 formed therein firstly comes into contact with the imprint material on the substrate. The driving mechanisms are provided on the detector 5-2 and the detector 5-3 (first detectors) so as to be movable for detecting the marks located near the center (first region) of the shot 10.

In Step 5-b1, the distance between the mold 3 and the substrate 2 is reduced in a manner described above, the marks are detected when simultaneous detection of the substrate-side marks 6 and the mold-side marks 7 is enabled, and then rough measurement is started. The expression “simultaneous detection is enabled” here means, for example, a case where both marks enter within a focus depth of the detectors 5 so that the relative position of both marks can be measured with high degree of accuracy. Therefore, the mold 3 and the imprint material do not have to be in contact with each other. The detector 5-2 and the detector 5-3 can be moved to positions near the center of the shot 10 as illustrated in FIG. 6A in advance before starting the rough measurement.

In Step 5-b2, a rough relative position of the mold 3 and the substrate 2 is aligned on the basis of the result of the rough measurement in Step 5-b1 (first alignment). The relative position between the mold 3 and the substrate 2 is aligned by driving at least one of the substrate stage 1 and the mold holding portion 4. At this time, the mold 3 and the imprint material are not in contact with each other yet, or the contact area between the mold 3 and the imprint material is still small. Therefore, a shearing force between the imprint material and the mold 3 is small, and thus distortion have a low impact on the substrate 2 and the pattern 9 even though the alignment is performed.

In Step 5-b3, the detectors 5 which have terminated the rough measurement in Step 5-b1 are moved to positions of the marks formed on the outer periphery of the shot 10 for further accurate measurement (scope driving). The larger the intervals of the marks to be detected, the more advantageous for calculating the deviation of the rotational component. Therefore, alignment by detecting the marks formed at positions near the outermost periphery of the shot is generally performed. However, since locations of the marks are affected by restriction of location and the like, the marks do not necessarily have to be located in the outermost periphery of the shot.

Subsequently, in Step 5-a3, the process of filling the pattern 9 with the imprint material is proceeded, and the imprint material is spread out to the end of the shot 10 (filling process).

In the embodiment, the detector 5-2 and the detector 5-3 measure (5-b1) the marks formed at positions near the center of the pattern 9 in the filling process in Step 5-a3 and then move to the positions of the marks (third region) formed at positions near the outermost periphery of the region where the pattern 9 is formed (5-b3). In addition, in the filling process in Step 5-a3, alignment (5-b2) between the substrate 2 and the mold 3 is performed.

If timing when contact between the imprint material and the pattern 9 is completed up to the end of the shot region in the filling process in Step 5-a3 is compared with timing when driving of the detectors 5 is completed by the scope driving in Step 5-b3, the timing when the contact between the imprint material and the pattern 9 is earlier in many cases. The reason is that a period of time required for the imprint material to come into contact with the pattern 9 to the end of the shot region is short by an impact of a capillary force. Since the imprint material and the pattern 9 are in contact with each other, but the entire concave portion of the pattern 9 is not completely filled with the imprint material, a period of time for filling the concave portion with the imprint material is required before an exposure process in Step 5-a4.

Therefore, waste of time may result if a start of fine measurement is waited until the scope driving in Step 5-b3 is completed. Therefore, even in the course of movement of the detectors 5 (the detector 5-2 and the detector 5-3 in the case of FIGS. 6A and 6B) that has detected the marks for the rough measurement, the fine measurement is started by using the detectors 5 (second detectors) which are not moving. Specifically, the detectors 5 which are not moving (the detectors 5-1, 5-4, 5-5, 5-6, 5-7, and 5-8 in the case of FIGS. 6A and 6B) detect the substrate-side marks 6 and the mold-side marks 7 and start the fine measurement in Step 5-c1. The detectors 5 which are not moving detect a second mark of a mold formed at a position near the outermost periphery of the region (second region) in which the pattern 9 is formed and a second mark on the substrate corresponding to the second mark on the mold. In Step 5-c2, the relative position and the shape difference between the substrate 2 and the mold 3 are measured by using the results of mark detection by the detectors 5 which are not moving, and alignment (second alignment) is performed on the basis of the result of measurement. In this manner, in the case where the plurality of detectors 5 constitute the imprint apparatus, detection of the marks by using all the detectors 5 provides the highest accuracy of alignment. However, even though the accuracy of alignment is reduced in some degree, an improvement of productivity may be achieved by starting the fine measurement by using the detectors 5 which are not moving.

In addition, when the movement of the detectors 5 (5-b3) is completed, the fine measurement by the moved detectors is started (5-b4). Specifically, the moved detectors 5 (the detector 5-2 and detector 5-3 in the case of FIGS. 6A and 6B) detect the substrate-side marks 6 (a third mark on the substrate) and the mold-side marks 7 (a third mark on the mold) and start the fine measurement. In Step 5-b5, measurement with high degree of accuracy is performed by using all of the detectors. Specifically, the relative position and the shape difference between the substrate 2 and the mold 3 are measured on the basis of the result of mark detection detected by the moved detectors 5 and the result of detection of the marks detected by the detectors 5 which are not moving. Then, alignment between the substrate 2 and the mold 3 (third alignment) is performed by driving at least one of the substrate stage 1 and the mold holding portion 4 on the basis of the result of measurement. Since the alignment is performed in Step 5-c2 by using the detectors 5 which are not moving, magnitudes of the amount of misalignment in relative position and the shape difference between the substrate 2 and the mold 3 measured by alignment in Step 5-b5 is small. Therefore, an amount of driving required for the alignment may be reduced and thus period of time required for the alignment may be reduced.

When the substrate 2 and the mold 3 achieve a relative position which satisfies a desired accuracy as a result of the alignment in Step 5-b5, the alignment process ends (5-b6). After the alignment process has ended, imprint material irradiated with UV light is cured (5-a4). In the embodiment, photo-curing resin which is cured by UV light is used as the imprint material. The wavelength of light irradiated for hardening the imprint material is not limited to the UV light, but may be determined depending on the nature of the imprint material. After the imprint material has been cured, in Step 5-a5, the mold 3 is separated from the imprint material cured by increasing the distance between the substrate 2 and the mold 3 (demolding process). By separating the mold 3 from the cured imprint material, the pattern of the imprint material can be formed on the substrate 2.

In this manner, according to the imprinting method illustrated in FIG. 5, significant driving for rough alignment can be performed in a former half of the filling process, and fine driving for accurate alignment can be performed in a latter half of the filing process. The embodiment provides an alignment method which achieves restriction of lowering of productivity by moving the detectors which have detected the marks at the time of beginning of contact between the mold 3 and the imprint material out of the plurality of detectors after the detection, and starting mark detection with other detectors in parallel during the filling process. Accordingly, an impact of the shearing force may be suppressed, and thus a force applied to the pattern 9 of the substrate 2 and the mold 3 may be suppressed. In addition, since measurement of the plurality of marks is performed by driving the detectors 5, an improvement of accuracy of alignment between the substrate 2 and the mold 3 is achieved. Since the period of time required for alignment may be suppressed while measuring the plurality of marks by using the detectors 5 located within a limited space in the imprint apparatus, lowering of productivity of the imprint apparatus may also be suppressed.

### Other Modes

In the embodiment, an example in which the detectors configured to detect the marks in the X-direction and the marks in the Y-direction are arranged. However, the location of the detectors is not limited thereto. The detectors configured to detect the marks in the X-direction and the marks in the Y-direction simultaneously may be employed. In this case, eight of the detectors are arranged in a configuration illustrated in FIG. 3. However, if the marks in the X-direction and the marks in the Y-direction are detected simultaneously, four of the detectors may be arranged. The larger the number of the marks, the higher the measurement accuracy is improved. However, the number of the marks is determined in view of a space in which the detectors can be arranged.

In the embodiment, the detectors to be moved for rough measurement have been described by using the detector 5-2 and the detector 5-3. However, the marks may be detected by increasing the number of the detectors to be moved. Accuracy of rougher alignment is improved by driving the plurality of detectors 5 and measuring a larger number of the marks, and an impact of the shearing force is suppressed to a low level. Although the shift component in the XY-direction may be measured by detecting the marks in the X-direction and the Y-direction at one position by using the detector 5-2 and the detector 5-3 as illustrated in FIG. 6A, the rotational component may be measured by increasing the number of positions of marks to be detected. In this case as well, period of time required for alignment may be reduced by starting the mark detection for accurate alignment by using the detectors which are not moving.

In the embodiment, the method of bring the mold 3 into contact with the imprint material by deforming the mold 3 into a convex shape toward the substrate 2 has been described as the method of bringing the mold 3 into contact with the imprint material. However, the method is not limited thereto. For example, a method of bringing the mold 3 into contact with the imprint material by inclining the mold 3 with respect to the substrate 2 without deforming the mold 3 to bring the mold 3 into contact with the imprint material gradually from one side of the shot region. In particular, in the case where the pattern is formed in the periphery of the substrate 2, the substrate 2 includes a region coming into contact with the imprint material on the pattern 9 of the mold 3 and a region not coming into contact with the imprint material. Therefore, the mold 3 can be inclined to achieve contact with the imprint material. In such a case as well, the rough measurement may be performed by moving the detectors to the position of starting contact with liquid and detecting the marks (marks formed in the first region). Rough alignment (first alignment) between the substrate 2 and the mold 3 may be performed on the basis of the result of measurement.

Mark detection and driving for alignment between the substrate 2 and the mold 3 on the basis of the result of detection are not limited to once, and the relative position between the substrate 2 and the mold 3 may be adjusted by performing the mark detection and alignment driving repeatedly.

### Method of Manufacturing Device

A method of manufacturing devices (semiconductor integrated circuit elements, liquid crystal display devices, and the like) as articles includes a process of forming a pattern on a substrate (a glass plate, a film-form substrate) by using the above-described imprint apparatus. The method of manufacturing further includes a process of etching the substrate on which the pattern is formed. In a case of manufacturing other articles such as patterned medium (recording medium) or optical devices, the method of manufacturing may include other processes which machine the substrate the pattern formed thereon instead of etching. The method of manufacturing an article of the embodiment is advantageous in at least one of performance, quality, productivity, and production cost of the articles in comparison with the method of the related art.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-006997, filed Jan. 16, 2015 which is hereby incorporated by reference herein in its entirety.

What is claimed is:

1. An imprint apparatus configured to form a pattern of an imprint material on a substrate by using a mold comprising:
a plurality of detectors configured to detect marks formed on the substrate and marks formed on the mold, the plurality of detectors including a first detector and a second detector; and
a control unit configured to control the imprint apparatus, the control unit
bringing the imprint material and the mold into contact with each other so that a first region and a second region of the mold contact sequentially with the imprint material,
causing the first detector to detect a first mark on the mold and a first mark on the substrate formed in the first region,
performing a first alignment between the substrate and the mold on the basis of a result of detection of the first mark on the mold and the first mark on the substrate, causing the first detector to detect the first mark on the mold and the first mark on the substrate, and then
causing the second detector to detect a second mark formed on the second region of the mold and a second mark on the substrate, while moving the first detector.

2. The imprint apparatus according to claim 1, wherein
the control unit causes the first detector to detect the first mark on the mold and the first mark on the substrate, and then moves the first detector while the first alignment is performed.

3. The imprint apparatus according to claim 1, wherein
the control unit obtains a relative position between the substrate and the mold from a result of detection of the second mark on the mold and the second mark on the substrate, and performs a second alignment between the substrate and the mold on the basis of the obtained relative position.

4. The imprint apparatus according to claim 1, wherein
the first mark formed on the mold comes into contact first with the imprint material on the substrate.

5. The imprint apparatus according to claim 1, wherein the first region corresponds to a center in a pattern region formed on the mold.

6. The imprint apparatus according to claim 1, wherein the second region corresponds to a periphery of the pattern region formed on the mold.

7. The imprint apparatus according to claim 1, wherein
the control unit moves the first detector, and then causes the first detector to detect a third mark on the mold and a third mark on the substrate formed in a third region which is different from the first region and the second region.

8. The imprint apparatus according to claim 7, wherein
the control unit obtains a relative position between the substrate and the mold from a result of detection of the third mark on the mold and the third mark on the substrate and performs a third alignment between the substrate and the mold on the basis of the obtained relative position.

9. The imprint apparatus according to claim 7, wherein the control unit performs the third alignment between the substrate and the mold on the basis of the result of detection of the second mark on the mold and the second mark on the substrate detected by the second detector, and the result of detection of the third mark on the mold and the third mark on the substrate detected by the first detector.

10. The imprint apparatus according to claim 7, wherein
the third region is a periphery of the pattern region formed on the mold.

11. The imprint apparatus according to claim 1, wherein
the first detector includes a plurality of detectors.

12. The imprint apparatus according to claim 1, wherein
the second detector includes a plurality of detectors.

13. A method of manufacturing articles comprising:
a process of forming a pattern of an imprint material on a substrate by using an imprint apparatus; and
a process of processing the substrate on which the pattern is formed in the previous step, wherein
the imprint apparatus is configured to form a pattern of an imprint material on a substrate by using a mold, the imprint apparatus including:
a plurality of detectors configured to detect marks formed on the substrate and marks formed on the mold, the plurality of detectors including a first detector and a second detector; and
a control unit configured to control the imprint apparatus, the control unit
bringing the imprint material and the mold into contact with each other so that a first region and a second region of the mold contact sequentially with the imprint material,
causing the first detector to detect a first mark on the mold and a first mark on the substrate formed in the first region,
performing a first alignment between the substrate and the mold on the basis of a result of detection of the first mark on the mold and the first mark on the substrate, and then
causing the first detector to detect the first mark on the mold and the first mark on the substrate, and then causing the second detector to detect a second mark formed on the second region of the mold and a second mark on the substrate while moving the first detector.

14. An imprinting method configured to form a pattern of an imprint material by bringing the imprint material on a substrate into contact sequentially with a first region and a second region of a mold, comprising:
a process of detecting a first mark on the mold and a first mark on the substrate formed in the first region by a first detector;
a process of alignment between the substrate and the mold on the basis of a result of detection detected by the process of detecting;
a process of moving the first detector for detecting a mark on the mold formed in a region different from the first region after the first detector has detected the first mark on the mold and the first mark on the substrate; and
a process of causing the second detector to detect a second mark formed in the second region of the mold and a second mark on the substrate while the first detector is moving.
